(19) United States
(12) Patent Application Publication
(10) Pub. No.: US 2018/0048482 A1
(43) Pub. Date: Feb. 15, 2018

(54) CONTROL SYSTEM AND CONTROL PROCESSING METHOD AND APPARATUS

(71) Applicant: Alibaba Group Holding Limited, Grand Cayman (KY)

(72) Inventor: Zhengbo WANG, Beijing (CN)

(21) Appl. No.: 15/674,147

(22) Filed: Aug. 10, 2017

(30) Foreign Application Priority Data
Aug. 11, 2016 (CN) 201610658833.6

(51) Int. Cl. H04L 12/28; H04W 4/18; G05B 19/045

(52) U.S. Cl. CPC H04L 12/2814; G05B 19/045; H04L 12/282; H04W 4/18; H04L 2012/2841; H04L 2012/2849; H04L 2012/285

(57) ABSTRACT

The complex operation and low control efficiency in controlling home devices, such as lights, televisions, and curtains, is reduced with a control system that senses the presence and any actions, such as hand gestures or speech, of a user in a predetermined space. In addition, the control system identifies a device to be controlled, and the command to be transmitted to the device in response to a sensed action.

### CROSS-REFERENCE TO RELATED APPLICATIONS

This application claims priority to Chinese Patent Application No. 201610658833.6, filed on Aug. 11, 2016, which is incorporated herein by reference in its entirety.

### TECHNICAL FIELD

The present application relates to the field of control, and in particular, to a control system and a control processing method and apparatus.

### BACKGROUND

Smart homes are an organic combination of various systems related to home life such as security, light control, curtain control, gas valve control, information household appliances, scene linkage, floor heating, health care, hygiene and epidemic prevention, security guard using advanced computer technologies, network communication technologies, comprehensive wiring technologies, and medical electronic technologies based on the principle of human engineering and in consideration of individual needs.

In the prior art, various smart home devices are generally controlled through mobile phone APPs corresponding to the smart home devices, and the smart home devices are controlled using a method of virtualizing the mobile phone APPs as remote controls. In the method of virtualizing mobile phone APPs as remote controls, a certain response waiting time exists during the control of the home devices. With the application of a large number of smart home devices, there are more and more operation interfaces of mobile phone APPs corresponding to various home devices, resulting in more and more frequent switching of the interfaces.

In view of the problem of complex operation and low control efficiency in controlling home devices in the prior art, an effective solution has not yet been proposed.

### SUMMARY

Embodiments of the present application provide a control system and a control processing method and apparatus to solve the technical problem of complex operation and low control efficiency in controlling home devices.

According to one aspect of the embodiments of the present application, a control system is provided that includes a collection unit to collect information in a predetermined space that includes a plurality of devices. The control system also includes a processing unit to determine, according to the collected information, pointing information of a user. In addition, the processing unit selects a target device to be controlled by the user from the plurality of devices according to the pointing information.

According to the aforementioned embodiments of the present application, the present application further provides a control processing method that includes collecting information in a predetermined space that includes a plurality of devices. The method also includes determining, according to the collected information, pointing information of a user. Further, the method includes selecting a target device to be controlled by the user from the plurality of devices according to the pointing information.

According to the aforementioned embodiments of the present application, the present application further provides a control processing apparatus that includes a first collection unit to collect information in a predetermined space that includes a plurality of devices. The control processing apparatus also includes a first determining unit to determine, according to the collected information, pointing information of a user. The control processing apparatus further includes a second determining unit to select a target device to be controlled by the user from the plurality of devices according to the pointing information.

By means of the aforementioned embodiments, a processing unit determines pointing information of a user's face appearing in a predetermined space according to information collected by a collection unit, determines a to-be-controlled device according to the indication of the pointing information, and then controls the determined device.

Through the aforementioned embodiments of the present application, a device to be controlled by a user can be determined based on pointing information of the user's face in a predetermined space so as to control the device. This process requires only collecting multimedia information to achieve the goal of controlling the device. The user does not need to switch among various operation interfaces of applications for controlling a device. The technical problem of complex operation and low control efficiency in controlling home devices is therefore solved, thereby achieving the goal of directly controlling a device according to the collected information with a simple operation.

### BRIEF DESCRIPTION OF THE DRAWINGS

The accompanying drawings described herein are used for providing further understanding of the present application and constitute a part of the present application. Exemplary embodiments of the present application and the description thereof are used for explaining the present application instead of constituting improper limitations on the present application. In the accompanying drawings:

FIG. 1 is a schematic diagram illustrating a control system 100 according to an embodiment of the present application;

FIG. 2 is a structural block diagram illustrating a computer terminal 200 according to an embodiment of the present application;

FIG. 3(a) is a flow diagram illustrating a control processing method 300 according to an embodiment of the present application;

FIG. 3(b) is a flow diagram illustrating an alternative control processing method 350 according to an embodiment of the present application;

FIG. 4 is a schematic structural diagram illustrating an alternative human-computer interaction system according to an embodiment of the present application;

FIG. 5 is a flow diagram of a method 500 illustrating an alternative human-computer interaction system according to an embodiment of the present application; and

FIG. 6 is a schematic diagram illustrating a control processing apparatus according to an embodiment of the present application.

### DETAILED DESCRIPTION OF THE EMBODIMENTS

To enable those skilled in the art to better understand the solutions in the present application, the technical solutions in the embodiments of the present application will be described clearly and completely below with reference to the drawings in the embodiments of the present application. The embodiments described below are merely some, rather than all, of the embodiments of the present application.

It should be noted that the terms such as “first” and “second” in the specification, the claims, and the aforementioned drawings of the present application are used to distinguish between similar objects, and are not necessarily used to describe a specific sequence or a sequence of priority. It should be understood that numbers used in this way are interchangeable in a suitable situation, so that the embodiments of the present application described herein can be implemented in a sequence in addition to a sequence shown or described herein. In addition, terms such as “include” and “have” and any variation thereof are intended to cover non-exclusive inclusion, for example, processes, methods, systems, products, or devices including a series of steps or units are not necessarily limited to the steps or units that are clearly listed, and may include other steps or units that are not clearly listed or that are inherent to the processes, methods, products, or devices.

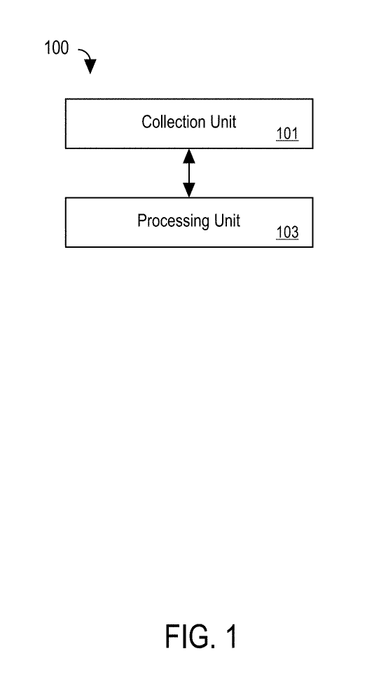

An embodiment of a control system is provided according to the embodiments of the present application. FIG. 1 is a schematic diagram of a control system 100 according to an embodiment of the present application. As shown in FIG. 1, control system 100 includes a collection unit 101 and a processing unit 103.

Collection unit 101 is configured to collect information in a predetermined space that includes a plurality of devices. The predetermined space may be one or more preset spaces, and areas included in the space may have fixed sizes or variable sizes. The predetermined space is determined based on a collection range of the collection unit. For example, the predetermined space may be the same as the collection range of the collection unit, or the predetermined space may be within the collection range of the collection unit.

For example, rooms of the user include an area A, an area B, an area C, an area D, and an area E. In this example, the area A is a space that changes, for example, a balcony. Any one or more of the area A, the area B, the area C, the area D, and the area E may be set as the predetermined space according to the collection capacity of the collection unit.

The collected information may include multimedia information, an infrared signal, and so on. Multimedia information is a combination of computer and video technologies, and the multimedia information mainly includes sounds and images. The infrared signal can represent a feature of a detected object through a thermal state of the detected object.

In an alternative embodiment, collection unit 101 may collect the information in the predetermined space through one or more sensors. The sensors include, but are not limited to, an image sensor, a sound sensor, and an infrared sensor. Collection unit 101 may collect environmental information and/or biological information in the predetermined space through the one or more sensors. The biological information may include image information, a sound signal, and/or biological sign information. In an embodiment, collection unit 101 may also be implemented through one or more signal collectors (or signal collection apparatuses).

In another alternative embodiment, collection unit 101 may include an image collection system that is configured to collect an image in the predetermined space such that the collected information includes the image.

The image collection system may be a DSP (Digital Signal Processor, namely, digital signal processing) image collection system, which can convert collected analog signals in the predetermined space into digital signals of 0 or 1. The DSP image collection system can also modify, delete, and enhance the digital signals, and then interpret digital data back into analog data or an actual environment format in a system chip. Specifically, the DSP image collection system collects an image in the predetermined space, converts the collected image into digital signals, modifies, deletes, and enhances the digital signals to correct erroneous digital signals, converts the corrected digital signals into analog signals to realize correction of analog signals, and determines the corrected analog signals as the final image.

In an embodiment, the image collection system may also be a digital image collection system, a multispectral image collection system, or a pixel image collection system.

In an alternative embodiment, collection unit 101 includes a sound collection system which can collect a sound signal in the predetermined space using a sound receiver, a sound collector, a sound card, or the like such that the collected information includes the sound signal.

Processing unit 103 is configured to determine, according to the collected information, pointing information of the user, and then select a target device to be controlled by the user from the plurality of devices according to the pointing information.

Specifically, the processing unit may determine, according to the collected information, pointing information of a user's face appearing in the predetermined space, and then determine a device to be controlled by the user according to the pointing information. In an alternative embodiment, after the information in the predetermined space has been collected, facial information of the user is extracted from the collected information.

Pose and spatial position information or the like of the user's face are determined based on the facial information, and pointing information is then generated. After the pointing information of the user's face has been determined, a user device pointed to by the pointing information is determined according to the pointing information, and the user device is determined as the device to be controlled by the user.

In order to improve accuracy, the pointing information of the user's face may be determined through pointing information of a facial feature point of the user. Specifically, after the information in the predetermined space is collected, when the information in the predetermined space contains human body information, information of one or more human facial feature points is extracted from the information. The pointing information of the user is determined based on the extracted information of the facial feature points, wherein the pointing information points to a device to be controlled by the user.

For example, information of a nose (the information contains a pointing direction of a certain local position of the nose, for example, a pointing direction of a nose tip) is extracted from the information, and the pointing information is determined based on the pointing direction of the nose. If information of a crystalline lens of an eye is extracted from the information, wherein the information may contain a pointing direction of a reference position of the crystalline lens, the pointing information is determined based on the pointing direction of the reference position of the crystalline lens of the eye.

When the facial feature points include the eye and the nose, the pointing information may be determined according to the information of the eye and the nose. Specifically, one piece of pointing information of the user's face may be determined through the orientation and angle of the crystalline lens of the eye, while the other piece of pointing information of the user's face may also be determined through the orientation and angle of the nose.

If the piece of pointing information of the user's face determined through the crystalline lens of the eye is consistent with the other piece of pointing information of the user's face determined through the nose, the pointing information of the user's face is determined as the pointing information of the user's face in the predetermined space. Further, after the pointing information of the user's face is determined, a device in the direction pointed to by the determined pointing information of the user's face is determined according to the pointing information, and the device in the pointed-to direction is determined as the to-be-controlled device.

Through the aforementioned embodiment, pointing information of a user's face in a predetermined space can be determined based on collected information in the predetermined space, and a device controlled by the user can be determined according to the pointing information of the user's face. By determining the controlled device using the pointing information of the user's face, the interaction between the human and the device is simplified, the interaction experience is improved, and control of different devices in the predetermined space is realized.

When the information includes an image, processing unit 103 is configured to determine that a user appears in the predetermined space when a human body appears in the image, and determine pointing information of the user's face.

In this embodiment, processing unit 103 detects whether the user appears in the predetermined space, and when the user appears in the predetermined space, determines pointing information of the user's face based on the collected information in the predetermined space.

The detecting whether the user appears in the predetermined space may be implemented through the following steps: detecting whether a human body feature appears in the image and, when a human body feature is detected in the image, determining that a user appears in the image in the predetermined space.

Specifically, image features of a human body may be pre-stored. After collection unit 101 collects an image, the image is identified using the pre-stored image features (namely, human body features) of the human body. If it is recognized that an image feature exists in the image, it is determined that the human body appears in the image.

When the collected information includes a sound, processing unit 103 is configured to determine pointing information of the user's face according to the sound signal.

Specifically, processing unit 103 detects whether the user appears in the predetermined space according to the sound signal and, when the user appears in the predetermined space, determines pointing information of the user's face based on the collected information in the predetermined space.

The detecting whether the user appears in the predetermined space according to the sound signal may be implemented through the following steps: detecting whether the sound signal comes from a human body and, when detecting that the sound signal comes from a human body, determining that the user appears in the predetermined space.

Specifically, sound features (for example, a human voice feature) of the human body may be pre-stored. After collection unit 101 collects a sound signal, the sound signal is recognized using the pre-stored sound features of the human body. If it is recognized that a sound feature exists in the sound signal, it is determined that the sound signal comes from the human body.

By means of the aforementioned embodiment of the present application, a collection unit collects information, and a processing unit performs human recognition according to the collected information. When recognizing that a human body appears in a predetermined space, processing unit 103 determines pointing information of the user's face so that whether a human body exists in the predetermined space can be accurately detected. When the human body exists, processing unit 103 determines pointing information of the human face, thereby improving the efficiency of determining the pointing information of the human face.

Through the aforementioned embodiment, processing unit 103 determines pointing information of a user's face appearing in a predetermined space according to information collected by a collection unit, determines a to-be-controlled device according to the indication of the pointing information, and then controls the determined device. Through the aforementioned embodiments of the present application, a device to be controlled by a user can be determined based on pointing information of the user's face in a predetermined space so as to control the device.

This process requires only collecting multimedia information to achieve the goal of controlling the device. The user does not need to switch among various operation interfaces of applications for controlling a device. The technical problem of complex operation and low control efficiency in controlling home devices in the prior art is therefore solved, thereby achieving the goal of directly controlling a device according to the collected information with a simple operation.

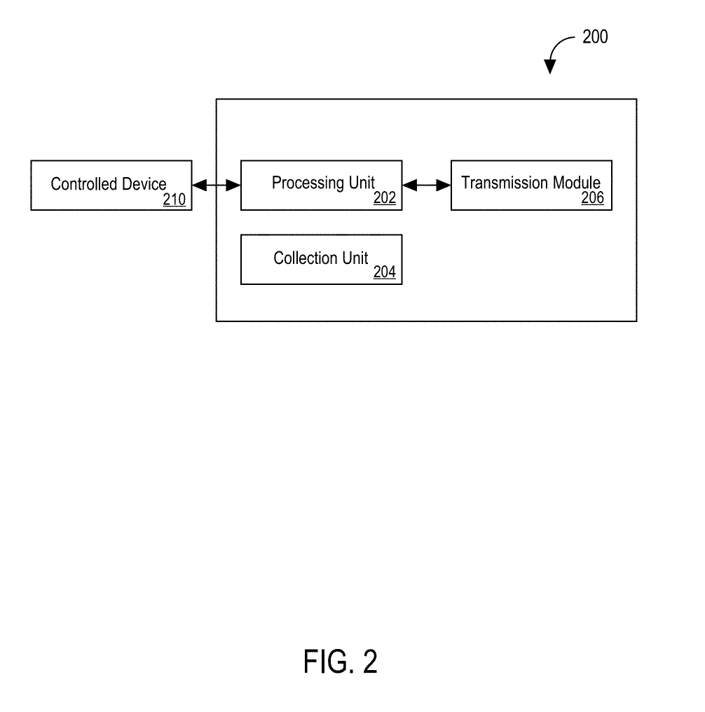

The embodiment provided in the embodiments of the present application may be implemented in a mobile terminal, a computer terminal, or a similar computing apparatus. Using running on a computer terminal as an example, FIG. 2 is a structural block diagram of a computer terminal 200 according to an embodiment of the present application.

As shown in FIG. 2, computer terminal 200 may include one or more (only one in the figure) processing units 202 (the processing units 202 may include, but are not limited to, a processing apparatus such as a microprocessing unit (MCU) or a programmable logic device (FPGA)), a memory configured to store data, a collection unit 204 configured to collect information, and a transmission module 206 configured to implement a communication function. Those of ordinary skilled in the art can understand that the structure shown in FIG. 2 is merely exemplary and does not constitute limitations on the structure of the aforementioned electronic apparatus. For example, computer terminal 200 may further include more or fewer components than those shown in FIG. 2, or have a different configuration from that shown in FIG. 2.

Transmission module 206 is configured to receive or send data via a network. Specifically, transmission module 206 may be configured to send a command generated by processing unit 202 to various controlled devices 210 (including the device to be controlled by the user in the aforementioned embodiment). A specific example of the aforementioned network may include a wireless network provided by a communication supplier of computer terminal 200.

In one example, transmission module 206 includes a network adapter (network interface controller, NIC), which may be connected to other network devices through a base station so as to communicate via the Internet. In one example, transmission module 206 may be a radio frequency (RF) module, which is configured to communicate with controlled device 210 in a wireless manner.

Examples of the aforementioned network include, but are not limited to, an internet, an intranet, a local area network, a mobile communication network, and a combination thereof.

An embodiment of a control processing method is further provided according to the embodiments of the present application. It should be noted that steps shown in the flow diagrams in the drawings may be executed in a computer system such as a set of computer executable instructions. Furthermore, although a logic sequence is shown in the flow diagrams, in some cases, the shown or described steps may be executed in a sequence different from the sequence herein.

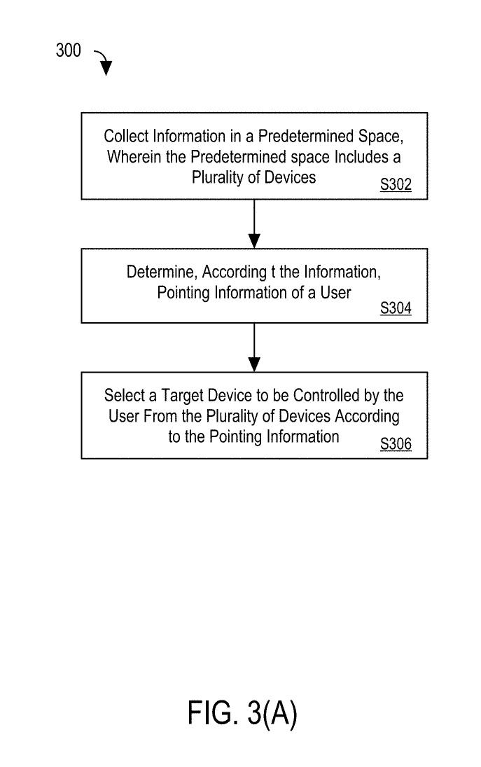

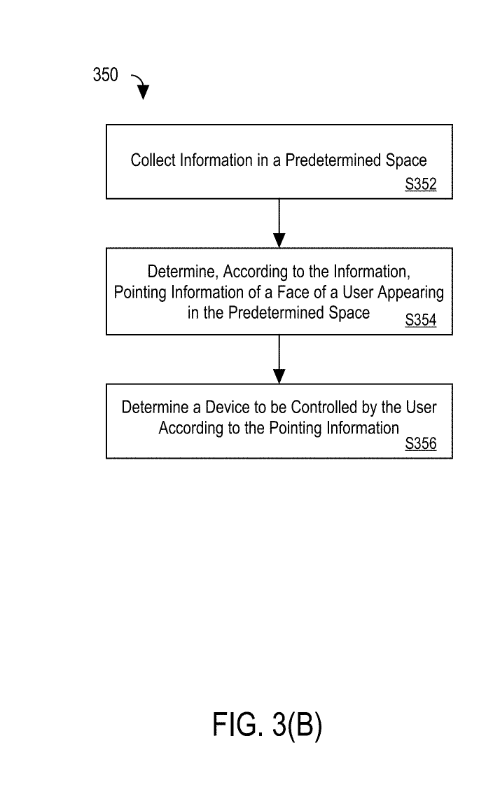

FIG. 3(a) shows a flow diagram that illustrates a control processing method 300 according to an embodiment of the present application. As shown in FIG. 3(a), method 300 begins at step S302 by collecting information in a predetermined space that includes a plurality of devices.

Method 300 next moves to step S304 to determine, according to the collected information, pointing information of a user. Following this, method 300 moves to step S306 to select a target device to be controlled by the user from the plurality of devices according to the pointing information.

By means of the aforementioned embodiment, after a collection unit collects information in a predetermined space, a processing unit determines pointing information of a user's face appearing in the predetermined space according to information collected by a collection unit, determines a to-be-controlled device according to the indication of the pointing information, and then controls the determined device.

Through the aforementioned embodiment, a device to be controlled by a user can be determined based on pointing information of the user's face in a predetermined space so as to control the device. This process requires only collecting multimedia information to achieve the goal of controlling the device. The user does not need to switch among various operation interfaces of applications for controlling a device. The technical problem of complex operation and low control efficiency in controlling home devices in the prior art is therefore solved, thereby achieving the goal of directly controlling a device according to the collected information with a simple operation.

Step S302 may be implemented by collection unit 101. The predetermined space may be one or more preset spaces, and areas included in the space may have fixed sizes or variable sizes. The predetermined space is determined based on a collection range of the collection unit. For example, the predetermined space may be the same as the collection range of the collection unit, or the predetermined space may be within the collection range of the collection unit.

For example, rooms of the user include an area A, an area B, an area C, an area D, and an area E. In this example, the area A is a space that changes, for example, a balcony. Any one or more of the area A, the area B, the area C, the area D, and the area E may be set as the predetermined space according to the collection capacity of the collection unit.

The information may include multimedia information, an infrared signal, and so on. The multimedia information is a combination of computer and video technologies, and the multimedia information mainly includes sounds and images. The infrared signal can represent a feature of a detected object through a thermal state of the detected object.

FIG. 3(b) shows a flow diagram that illustrates an alternative control processing method 350 according to an embodiment of the present application. As shown in FIG. 3(b), method 350 begins at step S352 to collect information in a predetermined space, and then moves to step S354 to determine, according to the collected information, pointing information of a user's face appearing in the predetermined space. Following this, method 350 moves to step S356 to determine a device to be controlled by the user according to the pointing information.

In the aforementioned embodiment, a device to be controlled by a user can be determined based on the pointing information of the user's face in a predetermined space so as to control the device. This process requires only collecting multimedia information to achieve the goal of controlling the device. The user does not need to switch among various operation interfaces of applications for controlling a device. The technical problem of complex operation and low control efficiency in controlling home devices in the prior art is therefore solved, thereby achieving the goal of directly controlling a device according to the collected information with a simple operation.

In an alternative embodiment, after the information in the predetermined space has been collected, facial information of the user is extracted from the collected information. Pose and spatial position information or the like of the user's face is determined based on the facial information, and pointing information is then generated. After the pointing information of the user's face is determined, a user device pointed to by the pointing information is determined according to the pointing information, and the user device is determined as the target device to be controlled by the user.

In order to further improve accuracy, the pointing information of the user's face may be determined through pointing information of a facial feature point of the user. Specifically, after the information in the predetermined space is collected, when the collected information in the predetermined space contains human body information, information of one or more human facial feature points is extracted from the information. The pointing information of the user is determined based on the extracted information of the facial feature points, wherein the pointing information points to a device to be controlled by the user.

For example, information of a nose (the information contains a pointing direction of a certain local position of the nose, for example, a pointing direction of a nose tip) is extracted from the information, and the pointing information is determined based on the pointing direction of the nose. If information of a crystalline lens of an eye is extracted from the information, wherein the information may contain a pointing direction of a reference position of the crystalline lens, the pointing information is determined based on the pointing direction of the reference position of the crystalline lens of the eye.

When the facial feature points include the eye and the nose, the pointing information may be determined according to the information of the eye and the nose. Specifically, one piece of pointing information of the user's face may be determined through the orientation and angle of the crystalline lens of the eye. The other piece of pointing information of the user's face may also be determined through the orientation and angle of the nose. If the piece of pointing information of the user's face determined through the crystalline lens of the eye is consistent with the other piece of pointing information of the user's face determined through the nose, the pointing information of the user's face is determined as the pointing information of the user's face in the predetermined space.

Further, after the pointing information of the user's face is determined, a device in the direction pointed to by the determined pointing information of the user's face is determined according to the pointing information, and the device in the pointed-to direction is determined as the to-be-controlled device.

Through the aforementioned embodiment, pointing information of a user's face in a predetermined space can be determined based on collected information in the predetermined space. In addition, a device controlled by the user can be determined according to the pointing information of the user's face so that by determining the controlled device using the pointing information of the user's face, the interaction between the human and the device is simplified, and the interaction experience is improved, thereby achieving the goal of controlling different devices in the predetermined space.

In an alternative embodiment, the information includes an image. Further, determining pointing information of a user according to the image includes determining that the image contains a human body feature, wherein the human body feature includes a head feature, acquiring a spatial position and a pose of the head feature from the image, and determining the pointing information according to the spatial position and the pose of the head feature so as to determine the target device in the plurality of devices.

The determining pointing information according to the image includes judging whether a human body appears in the image and, when judging that the human body appears, acquiring a spatial position and a pose of a head of the human body.

In an embodiment, it is judged whether a human body appears in the collected image and, when the human body appears, feature recognition is performed on the image to recognize a spatial position and a pose of a head feature of the human body.

Specifically, a three-dimensional space coordinate system (the coordinate system includes an x axis, a y axis, and a z axis) is established for the predetermined space, it is judged whether a human body exists in the collected image according to the image, and when the human body appears, a position r_{f}(x_{f}, y_{f}, z_{f}) of a head feature of the human body is acquired, wherein f indicates the human head, r_{f}(x_{f}, y_{f}, z_{f}) is spatial position coordinates of the human head, x_{f} is an x-axis coordinate of the human head in the three-dimensional space coordinate system, y_{f} is a y-axis coordinate of the human head in the three-dimensional space coordinate system, and z_{f} is a z-axis coordinate of the human head in the three-dimensional space coordinate system. When the human body appears, a pose R_{f}(ψ_{f}, θ_{f}, φ_{f}) of a human head is acquired, wherein ψ_{f}, θ_{f}, φ_{f} is used to indicate an Euler angle of the human head, ψ_{f} is used to indicate an angle of precession, θ_{f} is used to indicate an angle of nutation, and φ_{f} is used to indicate an angle of rotation, and then the pointing information is determined according to the determined position of the head feature and the determined pose R_{f}(ψ_{f}, θ_{f}, φ_{f}) of the head feature of the human body.

After the spatial position of the head and the pose of the head of the human body are acquired, a pointing ray is determined using the spatial position of the head feature of the human body as a starting point and the pose of the head feature as a direction. The pointing ray is used as the pointing information, and the device (namely, the target device) to be controlled by the user is determined based on the pointing information.

In an alternative embodiment, device coordinates of the plurality of devices corresponding to the predetermined space are determined. A device range of each device is determined based on a preset error range and the device coordinates of each device. A device corresponding to a device range pointed to by the pointing ray is determined as the target device, wherein if the pointing ray passes through the device range, it is determined that the pointing ray points to the device range.

The device coordinates may be three-dimensional coordinates. In an embodiment, after the three-dimensional space coordinate system is established, three-dimensional coordinates of various devices in the predetermined space are determined, and a device range of each device is determined based on a preset error range and the three-dimensional coordinates of each device, and after the pointing ray is acquired. If the ray passes through a device range, a device corresponding to the device range is the device (namely, the target device) to be controlled by the user.

By means of the aforementioned embodiment of the present application, after an image in a predetermined space is collected, human recognition is performed according to the collected image. When recognizing a human body, facial information of the human body is acquired, and then pointing information of the user's face is determined so that it can be accurately detected whether a human body exists in the predetermined space. When the human body exists, pointing information of the human face is determined, thereby improving the efficiency of determining the pointing information of the human face.

According to the aforementioned embodiment of the present application, when judging that a human body appears, the method further includes determining a posture feature and/or a gesture feature in a human body feature in the image, and controlling the target device according to a command corresponding to the posture feature and/or the gesture feature.

After the image in the predetermined space is collected, in the process of performing human recognition according to the collected image, pointing information of a face of a human body is acquired, and a posture or a gesture of the human body in the image may further be recognized so as to determine a control instruction (namely, the aforementioned command) of the user.

Specifically, commands corresponding to posture features and/or gesture features may be preset, the set correspondence is stored in a data table, and after a posture feature and/or a gesture feature is identified, a command matching the posture feature and/or the gesture feature is read from the data table. As shown in Table 1, this table records the correspondence between postures, gestures, and commands. A pose feature is used to indicate a pose of the human body (or user), and a gesture feature is used to indicate a gesture of the human body (or user).

TABLE 1

| Posture feature | Gesture feature | Command |
|---|---|---|
| Lying posture | Palm to fist | Turn on |
| Lying posture | Fist to palm | Turn off |
| Sitting posture | Wave | Open/Turn on |
| Standing posture | Wave | Close/Turn off |

In the embodiment shown in Table 1, when facial information of the user points to a device M in the area A, for example, the facial information of the user points to curtains on the balcony. When recognizing the posture as a sitting posture and the gesture as a wave, the corresponding command read from Table 1 is Open/Turn on, and then an Open command is issued to the device M (for example, the curtains) to control the curtains to open.

By means of the aforementioned embodiment of the present application, when facial information of the user is determined, a posture and/or a gesture of the human body may further be recognized, and a device pointed to by the facial information is controlled through a preset control instruction corresponding to the posture and/or the gesture of the human body to perform a corresponding operation. An operation that a device is controlled to perform can be determined when the controlled device is determined so that the waiting time in human-computer interaction is reduced to a certain extent.

In another alternative embodiment, the collected information includes a sound signal, wherein the determining pointing information of a user according to the sound signal includes: determining that the sound signal contains a human voice feature; determining position information of a source of the sound signal in the predetermined space and a propagation direction of the sound signal according to the human voice feature; and determining the pointing information according to the position information of the source of the sound signal in the predetermined space and the propagation direction so as to determine the target device in the plurality of devices.

Specifically, it may be determined whether the sound signal is a sound produced by a human body. When determining that the sound signal is a sound produced by the human body, position information of the source of the sound signal in the predetermined space and a propagation direction of the sound signal are determined, and the pointing information is determined according to the position information and the propagation direction so as to determine the device (namely, the target device) to be controlled by the user.

Further, a sound signal in the predetermined space may be collected. After the sound signal is collected, it is determined according to the collected sound signal whether the sound signal is a sound signal produced by a human body. After the sound signal is determined as a sound signal produced by the human body, a source position and a propagation direction of the sound signal are further acquired, and the pointing information is determined according to the determined position information and propagation direction.

It should be noted that a pointing ray is determined using the position information of the source of the sound signal in the predetermined space as a starting point and the propagation direction as a direction. The pointing ray is used as the pointing information.

In an alternative embodiment, device coordinates of the plurality of devices corresponding to the predetermined space are determined. A device range of each device is determined based on a preset error range and the device coordinates of each device. A device corresponding to a device range pointed to by the pointing ray is determined as the target device. If the pointing ray passes through the device range, it is determined that the pointing ray points to the device range.

The device coordinates may be three-dimensional coordinates. In an embodiment, after the three-dimensional space coordinate system is established, three-dimensional coordinates of various devices in the predetermined space are determined, and a device range of each device is determined based on a preset error range and the three-dimensional coordinates of each device, and after the pointing ray is acquired. If the ray passes through a device range, a device corresponding to the device range is the device (namely, the target device) to be controlled by the user.

For example, the user stands in the bedroom facing the balcony and produces a sound “Open” to the curtains on the balcony. First, after a sound signal “Open” is collected, it is judged whether the sound signal “Open” is produced by a human body. After it is determined that the sound signal is produced by the human body, a source position and a propagation direction of the sound signal, namely, a position at which the human body produces the sound and a propagation direction of the sound, are acquired. Pointing information of the sound signal is then determined.

By means of the aforementioned embodiment of the present application, pointing information can be determined not only through a human face but also through a human sound so that flexibility of human-computer interaction is further increased. Different approaches are also provided for determining the pointing information.

Specifically, when determining that the sound signal is a sound produced by the human body, speech recognition is performed on the sound signal to acquire a command corresponding to the sound signal. The target device is controlled to execute the command, wherein the device is the device determined to be controlled by the user according to the pointing information.

Further, after the pointing information of the sound signal “Open” is determined, speech recognition is performed on the sound signal. For example, the semantics of the sound signal “Open” after being parsed in the system is recognized as “Start.” A speech command, for example, a start command, after parsing, is acquired. Afterwards, the curtains are controlled through the start command to perform a start operation.

It should be noted that in the speech recognition, corresponding service speech and semantics recognition may be performed based on different service relations. For example, “Open/Turn on” instructs curtains to be opened in the service of curtains, televisions to be turned on in the service of televisions, and lights to be turned on in the service of lights.

By means of the aforementioned embodiment of the present application, a speech signal may be converted through speech recognition into a speech command corresponding to different services recognizable by various devices. A device pointed to by the sound signal is then controlled through the instruction to perform a corresponding operation so that the devices can be controlled more conveniently, rapidly, and accurately.

In an embodiment, a microphone array is used to measure the speech propagation direction and sound production position, which can achieve a similar effect to that of recognizing the head pose and position in the image.

In an embodiment, a unified interaction platform may be installed to multiple devices in a scattered manner. For example, image and speech collection systems are installed on all the multiple devices to separately perform human face recognition and pose judgment rather than performing unified judgment.

In an alternative embodiment, after the pointing information of the user is determined by collecting image information in the predetermined space, another piece of information in the predetermined space may be collected. The another piece of information is identified to obtain a command corresponding to the another piece of information, and the device is controlled to execute the command, wherein the device is the device determined to be controlled by the user according to the pointing information.

That is, in this embodiment, the pointing information and the command may be determined through different information, thereby increasing flexibility of processing. For example, after lights are determined as devices to be controlled by the user, the lights are turned on after the user issues a light-up command. At this time, another piece of information in the predetermined space is further collected. For example, the user issues a Bright command, and then an operation of adjusting the brightness is further performed.

By means of the aforementioned embodiment of the present application, the device may be further controlled by collecting another piece of information in the predetermined space so that various devices can be controlled continuously.

Specifically, the another piece of information may include at least one of the following: a sound signal, an image, and an infrared signal. That is, the device already controlled by the user may be further controlled through an image, a sound signal, or an infrared signal to perform a corresponding operation, thereby further improving the experiencial effect of the human-computer interaction. Moreover, nondirectional speech and gesture commands are reused using directional information of a human face so that the same command can be used for multiple devices.

For example, pointing information and a command of the user may be determined through an infrared signal. In the process of performing human recognition according to a collected infrared signal, pointing information of a face of a human body carried in the infrared signal is recognized. A posture or a gesture of the human body may be extracted from the infrared information for recognition so as to determine a control instruction (namely, the aforementioned command) of the user.

In an alternative embodiment, after the pointing information of the user is determined by collecting an image in the predetermined space, a sound signal in the predetermined space may be collected. The sound signal is recognized to obtain a command corresponding to the sound signal, and the controlled device is controlled to execute the command.

In another alternative embodiment, after the pointing information of the user is determined by collecting a sound signal in the predetermined space, an infrared signal in the predetermined space may be collected. The infrared signal is recognized to obtain a command corresponding to the infrared signal, and the controlled device is controlled to execute the command.

In an embodiment, image recognition and speech recognition in the aforementioned embodiment of the present application may choose to use an open source software library. The image recognition may choose to use a relevant open source project, for example, openCV (Open Source Computer Vision Library, namely, cross-platform computer vision library), dlib (an open source, cross-platform, general-purpose library written using modern C++ techniques), or the like. The speech recognition may use a relevant open source speech project, for example, openAL (Open Audio Library, namely, cross-platform audio API) or HKT (Hidden Markov Model Toolkit).

It should be noted that in order to briefly describe each foregoing method embodiment, all the method embodiments are expressed as a combination of a series of actions, but those skilled in the art should know that the present application is not limited by the sequence of the described actions because certain steps can adopt other sequences or can be carried out at the same time according to the present application. In addition, those skilled in the art should also know that all the embodiments described in the description belong to preferred embodiments, and the involved actions and modules are not necessarily required by the present application.

Through the preceding description of the embodiments, those skilled in the art can clearly understand that the method in the aforementioned embodiment may be implemented by software plus a necessary general hardware platform, and certainly may also be implemented by hardware. In most cases, however, the former is a preferred implementation mode. Based on such understanding, the essence of the technical solutions of the present application or the part that makes contributions to the prior art may be embodied in the form of a software product. The computer software product is stored in a storage medium (for example, a ROM/RAM, a magnetic disk, or an optical disk) and includes several instructions for instructing a terminal device (which may be a mobile phone, a computer, a server, a network device, or the like) to perform the methods described in the embodiments of the present application.

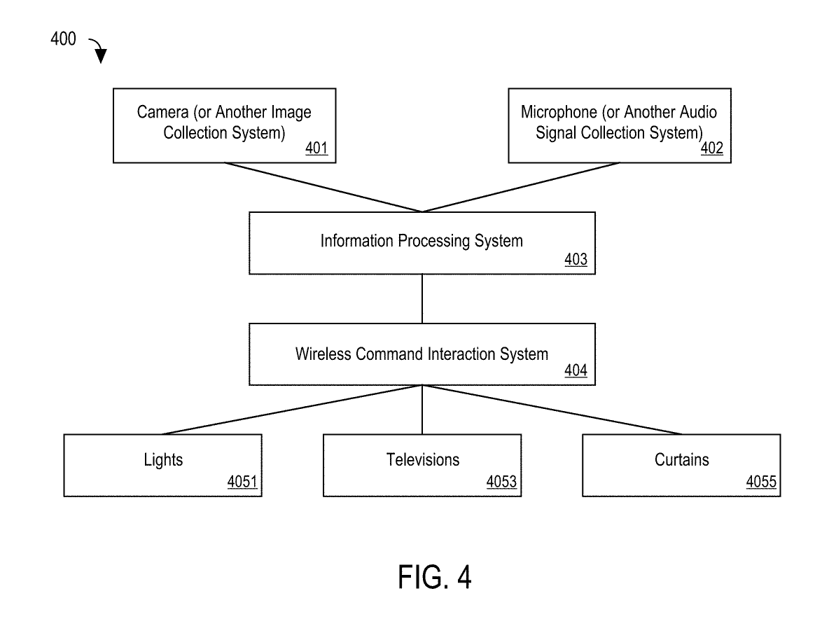

An embodiment of the present application is described in detail below with reference to FIG. 4. A control system 400 (for example, a human-computer interaction system) shown in FIG. 4 includes: a camera 401 or other image collection system, a microphone 402 or other audio signal collection system, an information processing system 403, a wireless command interaction system 404, and controlled devices (the controlled devices include the aforementioned device to be controlled by the user), wherein the controlled devices include: lights 4051, televisions 4053, and curtains 4055.

The camera 401 and the microphone 402 in this embodiment are included in collection unit 101 in the embodiment shown in FIG. 1. Information processing system 403 and wireless command interaction system 404 are included in processing unit 103 in the embodiment shown in FIG. 1.

The camera 401 and the microphone 402 are respectively configured to collect image information and audio information in the activity space of the user and transfer the collected information to information processing system 403 for processing.

Information processing system 403 extracts pointing information of the user's face and a user instruction. Information processing system 403 includes a processing program and hardware platform, which may be implemented in a form including, but not limited to, a local architecture and a cloud architecture.

For the pointing information of the user's face and the user instruction that are extracted by information processing system 403, wireless command interaction system 404 sends, using radio waves or in an infrared manner, the user instruction to the controlled devices 4051, 4053, 4055 specified by the pointing information of the user's face.

The device in the embodiment of the present application may be an intelligent device, and the intelligent device may communicate with processing unit 103 in the embodiment of the present application. For example, the intelligent device may also include a processing unit and a transmission or communication module. The intelligent device may be a smart home appliance, for example, a television, or the like.

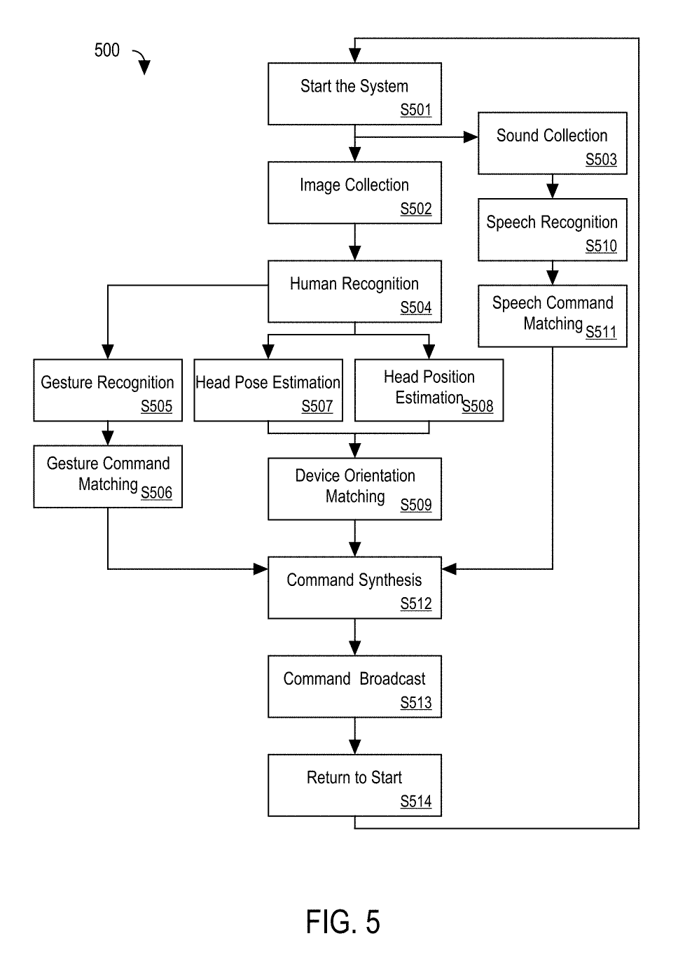

FIG. 5 shows a flow diagram of a method 500 illustrating an alternative human-computer interaction system according to an embodiment of the present application. The control system shown in FIG. 4 may control the device according to the steps shown in FIG. 5.

As shown in FIG. 5, method 500 begins at step S501 by starting the system. After the control system (for example, the human-computer interaction system) shown in FIG. 4 has been started, method 500 separately performs step S502 and step S503 to collect an image and a sound signal in a predetermined space.

In step S502, method 500 collects an image. An image in the predetermined space may be collected using an image collection system. Following this, method 500 moves to step S504 to recognize whether a human is present. After the image collection system collects the image in the predetermined space, human recognition is performed on the collected image to determine whether a human body exists in the predetermined space. When recognizing that the human body exists in the predetermined space, method 500 separately performs step S505, step S506, and step S507.

In step S505, method 500 recognizes a gesture. When recognizing that the human body exists in the predetermined space, a human gesture is recognized on the collected image in the predetermined space so as to acquire an operation to be performed by the user through a recognized gesture.

Following this, method 500 moves to step 506 to match gesture commands. After the gesture of the human body is recognized, the human-computer interaction system matches the recognized human gesture with a gesture command stored in the system so as to control, through the gesture command, the controlled device to perform a corresponding operation.

In step S507, method 500 estimates a head pose. When recognizing that the human body exists in the predetermined space, a human head pose is estimated on the collected image in the predetermined space so as to determine a device to be controlled by the user through a recognized head pose.

In step S508, method 500 estimates a head position. When recognizing that the human body exists in the predetermined space, a human head position estimation is performed on the collected image in the predetermined space so as to determine a device to be controlled by the user through a recognized head position.

After step 507 and step 508, method 500 matches device orientations in step S509. In a three-dimensional space coordinate system established in the predetermined space, the human-computer interaction system determines coordinates r_{d}(x_{d}, y_{d}, z_{d}) of the to-be-controlled device indicated by the pointing information according to a pose Euler angle R_{f}(ψ_{f}, θ_{f}, φ_{f}) of the human head and spatial position coordinates r_{f}(x_{f}, y_{f}, z_{f}) of the head, wherein x_{d}, y_{d}, z_{d} are respectively a horizontal coordinate, a longitudinal coordinate, and a vertical coordinate of the controlled device.

In an embodiment, the three-dimensional space coordinate system is established in the predetermined space, and the pose Euler angle R_{f}(ψ_{f}, θ_{f}, φ_{f}) of the human head and the spatial position coordinates r_{f}(x_{f}, y_{f}, z_{f}) of the head are obtained using the human-computer interaction system.

In the process of determining the coordinates of the controlled device, a certain pointing error (or error range) ε is allowed. In an embodiment, in the process of determining the coordinates of the target controlled device, a ray may be drawn using r_{f} as the starting point and R_{f} as the direction, and if the ray (namely, the aforementioned pointing ray) passes through a sphere (namely, the device range in the aforementioned embodiment) using r_{d} as the center and ε as the radius, it is determined that the human face points to the target controlled device (namely, the device to be controlled by the user in the aforementioned embodiment).

It should be noted that the aforementioned step S506 to step S508 are performed without precedence.

As noted above, after starting in step 501, method 500 also collects sound in step S503. A sound signal in the predetermined space may be collected using an audio collection system. After this, method 500 moves to step S510 to perform speech recognition. After the audio collection system collects the sound signal in the predetermined space, the collected sound signal is recognized to judge whether the sound signal is a sound produced by the human body.

Next, method 500 moves to step S511 to perform speech command matching. After the collected sound signal is recognized as a sound produced by the human body, the human-computer interaction system matches the recognized speech information with a speech command stored in the system so as to control, through the speech command, the controlled device to perform a corresponding operation.

After step S506, step S509, and step S511 have been performed, method 500 performs command synthesis in step S512. The matched gesture command and speech command are synthesized with the controlled device to generate a synthetic command so as to instruct the controlled device to perform a synthetic operation.

Following this, method 500 moves to step S513 to perform command broadcast. After various commands are synthesized, the synthetic command is broadcast (namely, sent and propagated) to control each to-be-controlled device to perform a corresponding operation. The command may be sent in a manner including, but not limited to, radio communication and infrared remote control. After this, method 500 moves to step S514, which returns method 500 back to the start.

The aforementioned human-computer interaction system includes an image processing part and a sound processing part. The image processing part is further divided into a human recognition unit and a gesture recognition unit. The image processing part first collects an image in the activity space (namely, the predetermined space) of the user, and then recognizes whether a human body image exists in the image.

If a human body image exists, the flow separately enters into a head recognition unit and the gesture recognition unit. In the head recognition unit, head pose estimation and head position estimation are performed, and then face orientation is solved by synthesizing the head pose and position. In the gesture recognition unit, a gesture of the user in the image is recognized and matched with a gesture command, and if the matching is successful, the command is output.

In the sound processing part, a sound signal is first collected, then speech recognition is performed on the sound signal to extract a speech command. If the extraction is successful, the command is output.

The commands output at the head recognition unit and the speech processing part are synthesized with a target device address obtained according to the face orientation to obtain a final command. Therefore, directional information is provided to the human-computer interaction system through the pose of the human face to accurately point to a specific device.

Using and reusing of multiple specific devices is made possible via a speech command and a gesture command. For example, when the user issues a speech command “Open/Turn on” facing different devices, the faced devices can be opened/turned on. For another example, when the user issues a gesture command “Palm to fist” facing different devices, the faced devices can be closed or turned off, and the like.

By means of the aforementioned embodiment of the present application, experience of human-computer interaction can be effectively improved, and the human-computer interaction is more flexible and human-centered.

It should be noted that the delay and costs of human-computer interaction in the aforementioned embodiment may be reduced in the following manners. In the first manner, a specific image recognition chip ASIC (Application Specific Integrated Circuit, namely, integrated circuit) may be used to reduce the delay, but the costs are high. In the second manner, an FPGA (Field-Programmable Gate Array) may be used to reduce the interaction delay and costs. In the third manner, an architecture such as x86 (a microprocessor) or arm (Advanced RISC Machines, namely, embedded RISC processor) may further be used to have low costs. A GPU (Graphic Processing Unit, namely, a graphics processor) may further be used to reduce the delay. In the fourth manner, all or some of processing programs are run on the cloud.

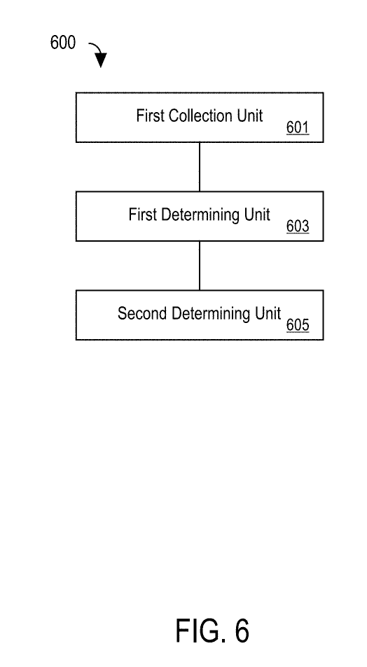

In the aforementioned running environment, a control processing apparatus is further provided. FIG. 6 shows a schematic diagram illustrating a control processing apparatus 600 according to an embodiment of the present application. As shown in FIG. 6, apparatus 600 includes a first collection unit 601 configured to collect information in a predetermined space that includes a plurality of devices.

Apparatus 600 also includes a first determining unit 603 configured to determine, according to the collected information, pointing information of a user, and a second determining unit 605 configured to select a target device to be controlled by the user from the plurality of devices according to the pointing information.

By means of the aforementioned embodiment, a processing unit determines pointing information of a face of a user appearing in a predetermined space according to information collected by a collection unit, and determines a to-be-controlled device according to indication of the pointing information, and then controls the determined device.

Through the aforementioned embodiment of the present application, a device to be controlled by a user can be determined based on pointing information of the user's face in a predetermined space so as to control the device. This process requires only collecting multimedia information to realize control on the device, without requiring the user to switch various operation interfaces of applications to realize control on the device. As a result, the technical problem of complex operation and low control efficiency in controlling home devices in the prior art is solved. In addition, the purpose of directly controlling a device according to collected information is achieved. Further, the operation is simple.

The aforementioned predetermined space may be one or more preset spaces, and areas included in the space may have fixed sizes or variable sizes. The predetermined space is determined based on a collection range of the collection unit. For example, the predetermined space may be the same as the collection range of the collection unit, or the predetermined space may be within the collection range of the collection unit.

For example, rooms of the user include an area A, an area B, an area C, an area D, and an area E. In the present example, the area A is a space that changes, for example, a balcony. Any one or more of the area A, the area B, the area C, the area D, and the area E may be set as the predetermined space according to the collection capacity of the collection unit.

The aforementioned information may include multimedia information, an infrared signal, and so on. The multimedia information is a combination of computer and video technologies, and mainly includes sounds and images. The infrared signal can represent a feature of a detected object through a thermal state of the detected object.

After the information in the predetermined space is collected, facial information of the user is extracted from the information, pose and spatial position information, or the like of the user's face is determined based on the facial information, and pointing information is generated. After the pointing information of the user's face is determined, a user device pointed to by the pointing information is determined according to the pointing information, and the user device is determined as the device to be controlled by the user.

In order to further improve accuracy, the pointing information of the user's face may be determined through pointing information of a facial feature point of the user. Specifically, after the information in the predetermined space is collected, when the information in the predetermined space contains human body information, information of one or more human facial feature points is extracted from the information. The pointing information of the user is determined based on the extracted information of the facial feature points, wherein the pointing information points to a device to be controlled by the user.

For example, information of a nose (the information contains a pointing direction of a certain local position of the nose, for example, a pointing direction of a nose tip) is extracted from the information, and the pointing information is determined based on the pointing direction of the nose. If information of a crystalline lens of an eye is extracted from the information, wherein the information may contain a pointing direction of a reference position of the crystalline lens, the pointing information is determined based on the pointing direction of the reference position of the crystalline lens of the eye.

When the facial feature points include the eye and the nose, the pointing information may be determined according to the information of the eye and the nose. Specifically, one piece of pointing information of the user's face may be determined through the orientation and angle of the crystalline lens of the eye, while the other piece of pointing information of the user's face may also be determined through the orientation and angle of the nose.

If the piece of pointing information of the user's face determined through the crystalline lens of the eye is consistent with the other piece of pointing information of the user's face determined through the nose, the pointing information of the user's face is determined as the pointing information of the user's face in the predetermined space. Further, after the pointing information of the user's face is determined, a device in the direction pointed to by the determined pointing information of the user's face is determined according to the pointing information, and the device in the pointed-to direction is determined as the to-be-controlled device.

Through the aforementioned embodiment, pointing information of a user's face in a predetermined space can be determined based on collected information in the predetermined space, and a device controlled by the user is determined according to the pointing information of the user's face. By determining the controlled device using the pointing information of the user's face, the interaction between the human and the device is simplified, interaction experience is improved, and control on different devices in the predetermined space is realized.

Specifically, when the information includes an image, and the pointing information is determined according to the image, the first determining unit may include: a first feature determining module configured to determine that the image contains a human body feature, wherein the human body feature includes a head feature; a first acquisition module configured to acquire a spatial position and a pose of the head feature from the image; and a first information determining module configured to determine the pointing information according to the spatial position and the pose of the head feature so as to determine the target device in the plurality of devices.

The first information determining module is specifically configured to determine a pointing ray using the spatial position of the head feature as a starting point and the pose of the head feature as a direction. The pointing ray is used as the pointing information.

By means of the aforementioned embodiment of the present application, after an image in a predetermined space is collected, human recognition is performed according to the collected image. When recognizing a human body, facial information of the human body is acquired, and then pointing information of the user's face is determined so that it can be accurately detected whether a human body exists in the predetermined space. When the human body exists, pointing information of the human face is determined, thereby improving the efficiency of determining the pointing information of the human face.

According to the aforementioned embodiment of the present application, the apparatus further includes: a first recognition module configured to, when determining that the image contains the human body feature, acquire a posture feature and/or a gesture feature from the image comprising the human body feature; and a first control module configured to control the target device according to a command corresponding to the posture feature and/or the gesture feature.

By means of the aforementioned embodiment of the present application, when facial information of the user is determined, a posture and/or a gesture of the human body may further be recognized, and a device pointed to by the facial information is controlled through a preset control instruction corresponding to the posture and/or the gesture of the human body to perform a corresponding operation. An operation that a device is controlled to perform can be determined when the controlled device is determined so that the waiting time in human-computer interaction is reduced to a certain extent.

According to the aforementioned embodiment of the present application, when the information includes a sound signal, and the pointing information is determined according to the sound signal, the first determining unit further includes: a second feature determining module configured to determine that the sound signal contains a human voice feature; a second acquisition module configured to determine position information of a source of the sound signal in the predetermined space and a propagation direction of the sound signal according to the human voice feature; and a second information determining module configured to determine the pointing information according to the position information of the source of the sound signal in the predetermined space and the propagation direction so as to determine the target device in the plurality of devices.

The second information determining module is specifically configured to: determine a pointing ray using the position information of the source of the sound signal in the predetermined space as a starting point and the propagation direction as a direction; and use the pointing ray as the pointing information.

By means of the aforementioned embodiment of the present application, pointing information can be determined not only through a human face but also through a human sound so that flexibility of human-computer interaction is further increased. Different approaches are also provided for determining the pointing information.

According to the aforementioned embodiment of the present application, the apparatus further includes: a second recognition module configured to, when determining that the sound signal contains the human voice feature, perform speech recognition on the sound signal to acquire a command corresponding to the sound signal; and a second control module configured to control the target device to execute the command.

By means of the aforementioned embodiment of the present application, a speech signal may be converted through speech recognition into a speech command corresponding to different services that is recognizable by various devices. A device pointed to by the sound signal is then controlled through the instruction to perform a corresponding operation so that the devices can be controlled more conveniently, rapidly, and accurately.

Further, after the device to be controlled by the user is determined, the apparatus further includes a second collection unit configured to collect another piece of information in the predetermined space.

A recognition unit is configured to recognize the another piece of information to obtain a command corresponding to the another piece of information. A control unit is configured to control the device to execute the command, wherein the device is the device determined to be controlled by the user according to the pointing information.

In an alternative embodiment, after the pointing information of the user is determined by collecting image information in the predetermined space, another piece of information in the predetermined space may be collected. The another piece of information is identified to obtain a command corresponding to the another piece of information. The device is controlled to execute the command, wherein the device is the device determined to be controlled by the user according to the pointing information. That is, in this embodiment, the pointing information and the command may be determined through different information, thereby increasing processing flexibility.

According to the aforementioned embodiment of the present application, the another piece of information includes at least one of the following: a sound signal, an image, and an infrared signal. That is, the device already controlled by the user may be further controlled through an image, a sound signal, or an infrared signal to perform a corresponding operation, thereby further improving the experiencial effect of the human-computer interaction. Moreover, nondirectional speech and gesture commands are reused using directional information of a human face so that the same command can be used for multiple devices.

An embodiment of the present application further provides a storage medium. In an embodiment, in this embodiment, the storage medium may be used for storing program code executed by the control processing method provided in the aforementioned Embodiment 1.

In an embodiment, in this embodiment, the storage medium may be located in any computer terminal in a computer terminal group in a computer network, or located in any mobile terminal in a mobile terminal group.

In an embodiment, in this embodiment, the storage medium is configured to store program code for executing the following steps: collecting information in a predetermined space; determining, according to the information, pointing information of a face of a user appearing in the predetermined space; and determining a device to be controlled by the user according to the pointing information.

By means of the aforementioned embodiments, a processing unit determines pointing information of a user's face appearing in a predetermined space according to information collected by a collection unit, determines a to-be-controlled device according to the indication of the pointing information, and then controls the determined device.

Through the aforementioned embodiments of the present application, a device to be controlled by a user can be determined based on pointing information of the user's face in a predetermined space so as to control the device. This process requires only collecting multimedia information to achieve the goal of controlling the device. The user does not need to switch among various operation interfaces of applications for controlling a device. The technical problem of complex operation and low control efficiency in controlling home devices in the prior art is therefore solved, thereby achieving the goal of directly controlling a device according to the collected information with a simple operation.

The aforementioned sequence numbers of the embodiments of the present application are merely for the convenience of description, and do not imply the preference among the embodiments.

In the aforementioned embodiments of the present application, the description of each embodiment has its own emphasis, and for a part that is not detailed in a certain embodiment, reference can be made to the relevant description of other embodiments.

In a few embodiments provided in the present application, it should be understood that the disclosed technical contents may be implemented in other manners. The apparatus embodiments described above are merely exemplary. For example, the division of units is merely logical function division and may be other division in actual implementation. For example, multiple units or components may be combined or integrated into another system, or some features may be ignored or not performed. In addition, the displayed or discussed mutual couplings or direct couplings or communication connections may be implemented through some interfaces, and the indirect couplings or communication connections between units or modules may be implemented in electrical or other forms.

The units described as separate parts may be or may not be physically separate, and the parts shown as units may be or may not be physical units, and not only can be located in one place, but also can be distributed onto a plurality of network units. Part or all of the units can be chosen to implement the purpose of the solutions of this embodiment according to actual requirements.

In addition, respective functional units in respective embodiments of the present application may be integrated into one processing unit, or respective units may physically exist alone, or two or more units may be integrated into one unit. The integrated unit can be implemented in the form of hardware or in the form of a software functional unit.

When being implemented in the form of a software functional unit and sold or used as a separate product, the integrated unit may be stored in a computer readable storage medium. Based on such understanding, the essence of the technical solutions of the present application, or the part that makes contributions to the prior art, or all or part of the technical solutions may be embodied in the form of a software product. The computer software product is stored in a storage medium and includes several instructions for instructing a computer device (which may be a personal computer, a server, a network device, or the like) to perform all or part of the steps in the methods described in the embodiments of the present application. The foregoing storage medium includes various media capable of storing program code, such as a USB flash drive, a read-only memory (ROM), a random access memory (RAM), a mobile hard disk, a magnetic disk, or an optical disk.

The above descriptions are merely preferred embodiments of the present application. It should be pointed out that those of ordinary skill in the art can make several improvements and modifications without departing from the principle of the present application, and the improvements and modifications should also be construed as falling within the protection scope of the present application.

What is claimed is:

1. A control system, comprising:
a collection unit to collect information in a predetermined space, the predetermined space including a plurality of devices; and
a processing unit to determine, according to the collected information, pointing information of a user, and select a target device to be controlled by the user from the plurality of devices according to the pointing information, the pointing information indicating a direction the user's face is pointed.

2. The control system according to claim 1, wherein:
the collection unit includes an image collection system to collect an image in the predetermined space, the collected information to include the image; and
the processing unit to determine the pointing information of the user when the image contains a human body feature.

3. The control system according to claim 1, wherein:
the collection unit includes a sound collection system to collect a sound signal in the predetermined space, the collected information to include the sound signal; and
the processing unit to determine the pointing information of the user according to the sound signal.

4. A control processing method, comprising:
collecting information in a predetermined space, the predetermined space including a plurality of devices;
determining, according to the collected information, pointing information of a user, the pointing information indicating a direction the user's face is pointed; and
selecting a target device to be controlled by the user from the plurality of devices according to the pointing information.

5. The method according to claim 4, wherein the collected information includes an image; and
the determining pointing information of a user according to the image includes:
determining whether the image includes a human body feature, the human body feature including a head feature;
acquiring a spatial position and a pose of the head feature from the image; and
determining the pointing information according to the spatial position and the pose of the head feature to determine the target device in the plurality of devices.

6. The method according to claim 5, wherein the determining the pointing information according to the spatial position and the pose of the head feature includes:
determining a pointing ray using the spatial position of the head feature as a starting point and the pose of the head feature as a ray direction; and
using the pointing ray as the pointing information.

7. The method according to claim 5, further comprising:
when determining whether the image contains the human body feature, acquiring a posture feature and/or a gesture feature from the image that includes the human body feature; and
controlling the target device according to a command corresponding to the posture feature and/or the gesture feature.

8. The method according to claim 4, wherein:
the collected information includes a sound signal, and
the determining pointing information of a user according to the sound signal includes:
determining that the sound signal contains a human voice feature;
determining position information of a source of the sound signal in the predetermined space and a propagation direction of the sound signal according to the human voice feature; and
determining the pointing information according to the position information of the source of the sound signal in the predetermined space and the propagation direction so as to determine the target device in the plurality of devices.

9. The method according to claim 8, wherein the determining the pointing information according to the position information of the source of the sound signal in the predetermined space and the propagation direction includes:
determining a pointing ray using the position information of the source of the sound signal in the predetermined space as a starting point and the propagation direction as a ray direction; and
using the pointing ray as the pointing information.

10. The method according to claim 8, further comprising:
when determining whether the sound signal contains the human voice feature, performing speech recognition on the sound signal to acquire a command corresponding to the sound signal; and
controlling the target device to execute the command.

11. The method according to claim 6, wherein the selecting a target device to be controlled by the user from the plurality of devices includes:
determining device coordinates of the plurality of devices corresponding to the predetermined space;
determining a device range for each device based on a preset error range and the device coordinates of each device; and
determining a device corresponding to a device range pointed to by the pointing ray as the target device, the pointing ray pointing to the device range when the pointing ray passes through the device range.

12. The method according to claim 5, wherein after the selecting a target device to be controlled by the user from the plurality of devices, the method further comprises:
collecting another piece of information in the predetermined space;
identifying the another piece of information to obtain a command corresponding to the another piece of information; and
controlling the device to execute the command, wherein the device is the device determined to be controlled by the user according to the pointing information.

13. The method according to claim 12, wherein the another piece of information includes one or more of the following: a sound signal, an image, and an infrared signal.

14. A control processing apparatus, comprising:
a first collection unit to collect information in a predetermined space, the predetermined space including a plurality of devices;
a first determining unit to determine, according to the collected information, pointing information of a user, the pointing information indicating a direction the user's face is pointed; and
a second determining unit to select a target device to be controlled by the user from the plurality of devices according to the pointing information.

15. The method according to claim 9, wherein the selecting a target device to be controlled by the user from the plurality of devices includes:
determining device coordinates of the plurality of devices corresponding to the predetermined space;
determining a device range for each device based on a preset error range and the device coordinates of each device; and
determining a device corresponding to a device range pointed to by the pointing ray as the target device, the pointing ray pointing to the device range when the pointing ray passes through the device range.

16. The method according to claim 8, wherein after the selecting a target device to be controlled by the user from the plurality of devices, further comprising:
collecting another piece of information in the predetermined space;
identifying the another piece of information to obtain a command corresponding to the another piece of information; and
controlling the device to execute the command, wherein the device is the device determined to be controlled by the user according to the pointing information.
